(19) United States
(12) Patent Application Publication
(10) Pub. No.: US 2008/0316364 A1
(43) Pub. Date: Dec. 25, 2008

(54) RATE DISTORTION OPTIMIZATION FOR VIDEO DENOISING

(75) Inventors: Oscar Chi Lim Au, Hong Kong (CN); Yan Chen, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/132,769

(22) Filed: Jun. 4, 2008

Related U.S. Application Data
(60) Provisional application No. 60/945,995, filed on Jun. 25, 2007.

(51) Int. Cl. H04N 5/00

(52) U.S. Cl. 348/608; 348/E05.001

(57) ABSTRACT

Based on maximum a posteriori (MAP) estimates, video denoising techniques for frames of noisy video are provided. With the assumptions that noise is similar to or satisfies Gaussian distribution and an a priori conditional density model measurable by bit rate, a MAP estimate of a denoised current frame can be expressed as a rate distortion optimization problem. A constraint minimization problem based on the rate distortion optimization problem is used to vary a lagrangian parameter to optimize the denoising process. The lagrangian parameter is determined as a function of distortion of the noise.

### CROSS-REFERENCE TO RELATED APPLICATIONS

This application claims priority to U.S. Provisional Application Ser. No. 60/945,995, filed on Jun. 25, 2007, entitled “RATE DISTORTION OPTIMIZATION FOR VIDEO DENOISING”, the entirety of which is incorporated herein by reference.

### TECHNICAL FIELD

The subject disclosure relates to video denoising and more particularly, to a maximum a posteriori (MAP) based optimization for denoising video.

### BACKGROUND

Video denoising is used to remove noise from a video signal. Video denoising methods have generally been divided into spatial and temporal video denoising. Spatial denoising methods analyze one frame for noise suppression and are similar to image noise reduction techniques. Temporal video denoising methods use temporal information embedded in the sequencing of the images, and can be further subdivided into motion adaptive methods and motion compensative methods. For instance, motion adaptive methods use analysis of pixel motion detection and attempt to average with previous pixels where there is no motion detected and, for example, motion compensative methods use motion estimation to predict and consider pixel values from a specific position in previous frame(s). As the name implies, spatial-temporal video denoising methods use a combination of spatial and temporal denoising.

Video noise can include analog noise and/or digital noise. For just a few examples of some various types of analog noise that can result in a corrupted video signal, such noise sources can include radio channel artifacts (high frequency interference, e.g., dots, short horizontal color lines, etc., brightness and color channels interference, e.g., problems with antenna, video reduplication—false contouring appearance), VHS tape artifacts (color specific degradation, brightness and color channels interference, chaotic shift of lines at the end of frame, e.g., line resync signal misalignment, wide horizontal noise strips), film artifacts (dust, dirt, spray, scratches on medium, curling, fingerprints), and a host of other analog noise types. For a few examples of some various types of digital noise that can result in a video signal, noise sources include blocking from low bitrate, ringing, block errors or damage in case of losses in digital transmission channel or disk injury, e.g., scratches on physical disks, and a host of other digital noise types.

Conventional video denoising methods have been designed for specific types of noise, e.g., noise with particular characteristics, and different suppression methods have been proposed to remove noise from video.

For instance, one conventional denoising system proposes the use of motion compensation (MC) with an approximated 3D Wiener filter. Another conventional denoising system proposes using a spatio-temporal Kalman filter. Such conventional methods require enormous amounts of computation and storage, however. While some systems have been proposed to reduce the computation and storage, their applicability is narrow. Moreover, standard H.264 encoders fix certain variables that are inherently not optimized for dependent characteristics of the noise, such as Gaussian noise, to which denoising is to be applied.

Accordingly, it would be desirable to provide a better solution for video denoising. The above-described deficiencies of current designs for video denoising are merely intended to provide an overview of some of the problems of today's designs, and are not intended to be exhaustive. For instance, other problems with the state of the art may become further apparent upon review of the following description of various non-limiting embodiments below.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments in a simplified form as a prelude to the more detailed description that follows.

Based on maximum a posteriori (MAP) estimates for previous frames of a noisy video sequence, video denoising techniques for frames of noisy video are provided. The noise is assumed Gaussian in nature and an a priori conditional density model is measured as a function of bit rate. A MAP estimate of a denoised current frame can thus be expressed as a rate distortion optimization problem. A constraint minimization problem based on the rate distortion optimization problem can be used to optimally set a variable lagrangian parameter to optimize the denoising process. The lagrangian parameter can be determined as a function of distortion of the noise and a quantization level associated with an encoding of the noisy video.

### BRIEF DESCRIPTION OF THE DRAWINGS

The MAP-based optimization techniques for video denoising are further described with reference to the accompanying drawings in which:

FIG. 1 illustrates a high-level block diagram of introduction of noise to a video signal due to storage, processing or transmission by communicatively coupled devices;

FIGS. 2 and 3 illustrate block diagrams for the addition and removal of noise after application of the denoising described herein, respectively;

FIG. 4 is an exemplary high level flow diagram applicable to a denoising process;

FIG. 5 is an exemplary flow diagram illustrating MAP-based techniques for determining an optimal reconstruction of an original video signal;

FIGS. 6, 7, 8 and 9 illustrate an original capture, an intentionally noised version, a reconstruction of the original capture after H.264 decompression and a reconstruction of the noised version after application of the denoising, respectively, in connection with a first original image;

FIGS. 10, 11, 12 and 13 illustrate an original capture, an intentionally noised version, a reconstruction of the original capture after H.264 decompression and a reconstruction of the noised version after application of the denoising, respectively, in connection with a second original image;

FIG. 14 is an additional flow diagram illustrating exemplary MAP-based techniques that can be applied to determine an optimal reconstruction of an original video signal;

FIG. 15 is an additional flow diagram illustrating exemplary MAP-based techniques that can be applied to determine an optimal reconstruction of an original video signal;

FIG. 16 is an block diagram illustrating exemplary MAP-based techniques that can be applied to determine an optimal reconstruction of an original video signal;

FIG. 17 is an additional flow diagram illustrating exemplary MAP-based techniques that can be applied to determine an optimal reconstruction of an original video signal;

FIG. 18 is a block diagram representing an exemplary non-limiting computing system or operating environment in which the various embodiments may be implemented; and

FIG. 19 illustrates an overview of a network environment suitable for service by embodiments of the denoising set forth below.

### DETAILED DESCRIPTION

### Overview

As discussed in the background, at a high level, video denoising relates to when an ideal video becomes distorted during the process of being digitized or transmitted, which can happen for a variety of reasons, e.g., due to motion of objects, a lack of focus or deficiencies of an optical system involved with capture of the video, etc. After capture and storage, video can become further distorted during transmission over noisy channels. The resulting noisy or distorted video is visually unpleasant and makes some tasks, such as segmentation, recognition and compression, more difficult to perform. It is thus desirable to be able to reconstruct an accurate estimate of the ideal video from the “corrupted” observations in an optimal manner to improve visual appearance, reduce video storage requirements and to facilitate additional operations performed on the video.

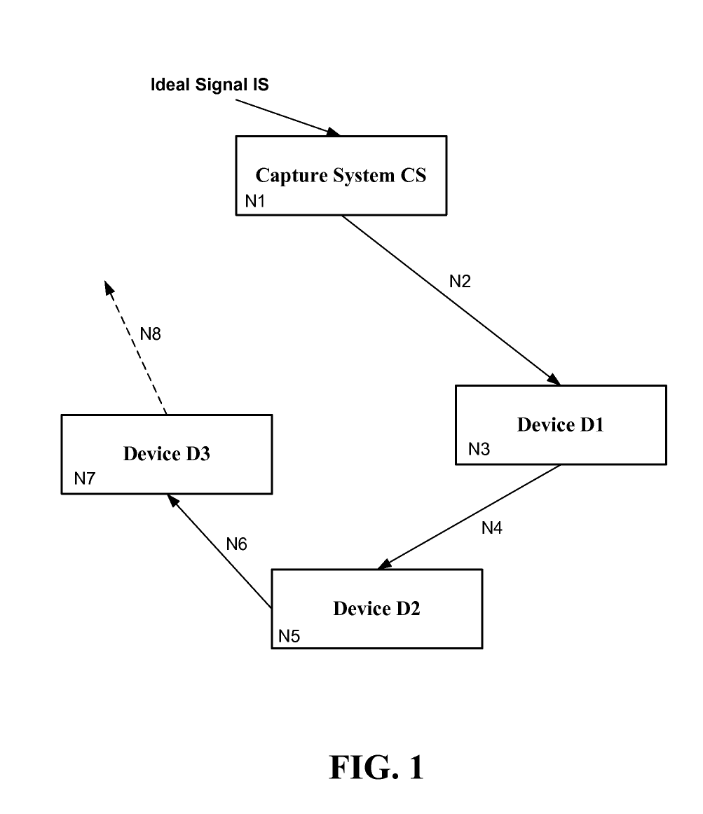

In consideration of these issues, various embodiments optimize video denoising processing by restoring video degraded by additive Gaussian noise having values following a Gaussian or normal amplitude distribution. FIG. 1 illustrates various sources for noise that may be introduced into video over its lifetime of distribution. For instance, a capture system CS may introduce noise N1 to an ideal signal IS. After capture, video with noise N1 may be transmitted to a device D1, introducing additional noise N2 due to potential errors in transmission or the like. Device D1 may also introduce yet additional noise N3 when receiving, storing, compressing or otherwise transforming the data. Then, similarly, as the video is transmitted from device D1 to device D2 or device D2 to device D3, and so on, additional noise N4, N6, N8 may be added to the video from transmission noise sources. Devices D2 and D3 may also introduce noise N5 and N7, respectively. Since a relatively high percentage of noise introduced into video approximates or has Gaussian characteristics, noise is assumed to be Gaussian in nature and the problem can be formulated as follows:

Iⁿ=I+n Eqn. 1

where I=[I₁, I₂ . . . Iₖ, Iₖ₊₁ . . . Iₘ]^{T} is the original, or ideal, video while Iₖ is the k-th frame, n=[n₁, n₂ . . . nₖ, nₖ₊₁ . . . nₘ]^{T} is the additive Gaussian noise, and Iⁿ=[I₁ⁿ, I₂ⁿ . . . Iₖⁿ, Iₖ₊₁ⁿ . . . Iₘⁿ]^{T} is the noisy observation of the video. Iₖ, nₖ, Iₖⁿ represent length-N vectors, where N is the number of pixels in each frame. In various non-limiting embodiments described below an estimate Î for the original, or ideal, video is provided based on an analysis of noisy video Iⁿ.

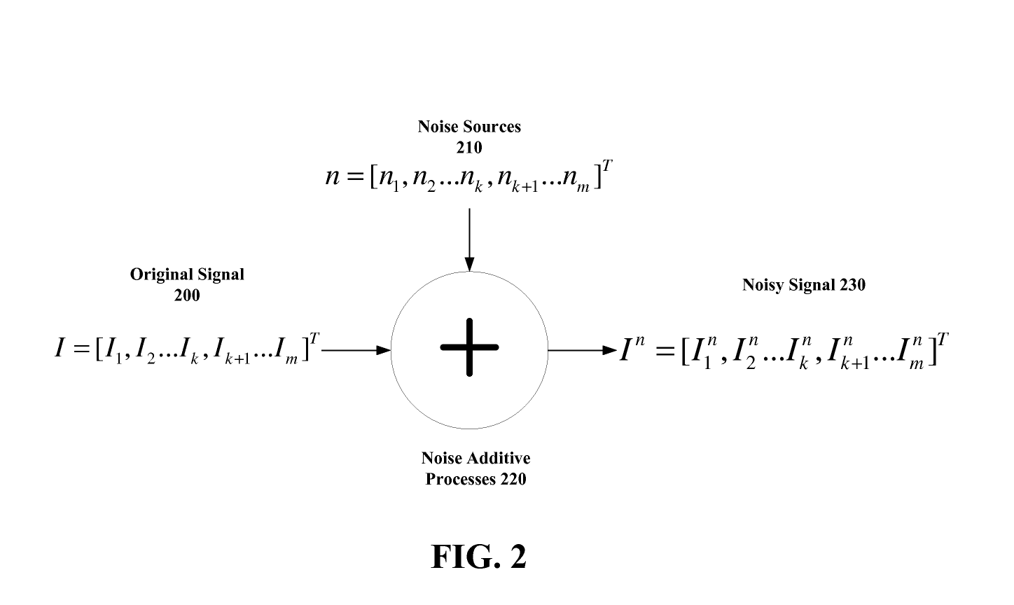

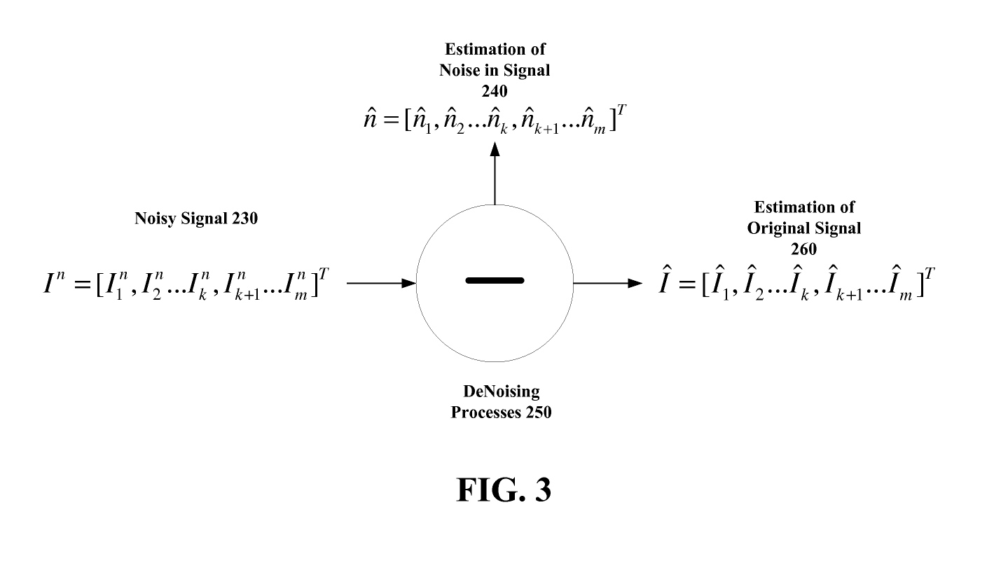

The above-described concepts are illustrated in the block diagram of FIGS. 2 and 3. For instance, FIG. 2 represents a general process for acquiring noise in a video signal, where an original signal 200 combines with noise via any of a variety of noise sources 210 via noise additive processes 220, resulting in noisy signal 230. As shown in FIG. 3, a solution to this problem is optimized by receiving noisy signal 230, performing a denoising process 250 that, among other things, optimally estimates noise 240 in noisy signal 230 based on an assumption that the noise 240 is Gaussian, a reasonable assumption covering a great variety of real-world noise additive scenarios. As a result of removing the estimated noise 240 by denoising processes 250, an optimal estimation of the original signal 260 can be calculated. The estimation of noise 240 may or may not be stored as part of denoising processes 250, e.g., noise 240 can be discarded. Some embodiments of the denoising processes 250 are described in more detail below.

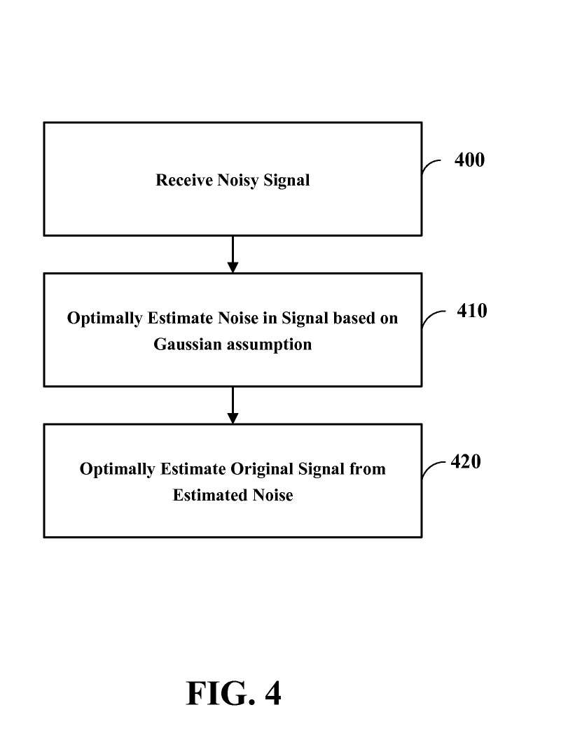

For instance, some embodiments can operate according to the flow diagram of FIG. 4. Any device or system may benefit from the overall process, i.e., wherever a device or system can benefit from a more faithful video signal to the original signal for further processing or reduced storage. At 400, a device receives a noisy signal. At 410, the noise is estimated based on an assumption that the noise has Gaussian characteristics, and at 420, the denoising process further estimates the original signal based on the estimate of the noise determined at 410.

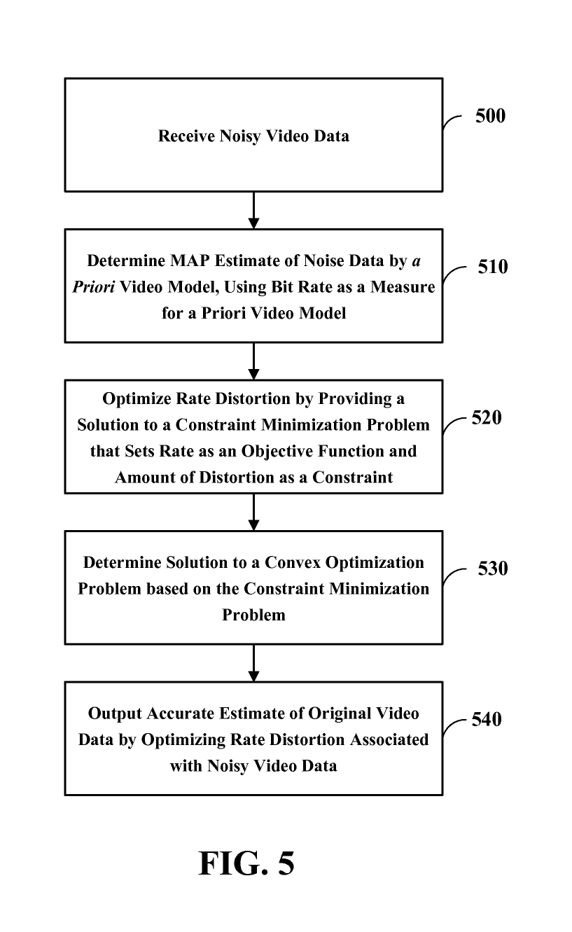

In this respect, maximum a posteriori (MAP) estimation techniques are used to perform video denoising, which are now described in more detail in connection with the flow diagram of FIG. 5. At 500, noisy video data is received. Based on the assumption that noise in video data tends to satisfy characteristic(s) of Gaussian distributions, at 510, a MAP estimate is determined by a video a priori model. By using bit rate as a measure of the a priori model, the problem identified above can be reformulated as a rate distortion optimization problem at 520. By setting the rate as an objective function and amount of distortion as a constraint, the problem can be further reformulated as a constraint minimization problem. In one aspect, the constraint minimization problem is overcome optimally by solving a convex optimization problem at 530. In this way, a MAP-Based video denoising solution is achieved via optimization of rate distortion associated with noisy video. An estimate of the original signal is then determined at 540.

Various embodiments and further underlying concepts of the denoising processing are described in more detail below.

### MAP-Based Video Denoising

According to Bayesian principles, a MAP-based video denoising technique is provided that determines a MAP estimate by two terms: a noise conditional density model and an a priori conditional density model. As mentioned, based on the above noted assumptions that the noise satisfies Gaussian distribution and the a priori model is measured by the bit rate, the MAP estimate can be expressed as a rate distortion optimization problem.

In order to find a suitable lagrangian parameter for the rate distortion optimization problem, the rate distortion problem is transformed to a constraint minimization problem by setting the rate as an objective function and the distortion as a constraint. In this way, the lagrangian parameter can be determined by the distortion constraint. Fixing the distortion constraint, the optimal lagrangian parameter is obtained, which in turn leads to an optimal denoising result.

In further non-limiting embodiments described below, additional details are provided regarding the MAP-based video denoising techniques and some results from exemplary implementations are set forth that demonstrate the effectiveness and efficiency of the various embodiments.

In accordance with an embodiment, since the input noisy videos are denoised frame by frame, when denoising frame Iₖⁿ, the estimated original versions of previous frames Î₁, . . . Îₖ₋₁ have already been reconstructed, which are the MAP estimate of previous frames. While in an exemplary implementation, one previous reference frame is used when denoising a current frame, it can be appreciated that the techniques can be extended to any number of previous reference frames. Given Îₖ₋₁ (reference frame) and Iₖⁿ (current noisy frame). the maximum a posteriori (MAP) estimate of the current frame Iₖ is set forth as:

$${\hat{I}}_{k} = arg { max}_{{I}_{k}} Pr ( {I}_{k} \vert {I}_{k}^{n} , {\hat{I}}_{k - 1} ) \qquad Eqn . 2$$

By using Bayes rule, Equation 2 can be expressed as:

$${\hat{I}}_{k} = arg { max}_{{I}_{k}} \frac{Pr ( {I}_{k}^{n} \vert {I}_{k} , {\hat{I}}_{k - 1} ) Pr ( {I}_{k} \vert {\hat{I}}_{k - 1} ) Pr ( {\hat{I}}_{k - 1} )}{Pr ( {I}_{k}^{n} , {\hat{I}}_{k - 1} )} \qquad Eqn . 3$$

Ignoring all the functions that are not related to Iₖ, the estimates of Equation 3 can be written as:

$${\hat{I}}_{k} = arg {max}_{{I}_{k}} Pr ( {I}_{k}^{n} \vert {I}_{k} , {\hat{I}}_{k - 1} ) Pr ( {I}_{k} \vert {\hat{I}}_{k - 1} ) \qquad Eqn . 4$$

Since Iₖⁿ=Iₖ+nₖ, Pr(Iₖⁿ|Iₖ, Îₖ₋₁) is equal to Pr(Iₖⁿ|Iₖ). Therefore, the estimates of Equation 4 can be further simplified as:

$${\hat{I}}_{k} = arg {max}_{{I}_{k}} Pr ( {I}_{k}^{n} \vert {I}_{k} ) Pr ( {I}_{k} \vert {\hat{I}}_{k - 1} ) \qquad Eqn . 5$$

Taking the “minus log” function of Equation 5 above results in:

$${\hat{I}}_{k} = arg {min}_{{I}_{k}} \{ - log [ Pr ( {I}_{k}^{n} \vert {I}_{k} ) ] - log [ Pr ( {I}_{k} \vert {\hat{I}}_{k - 1} ) ] \} \qquad Eqn . 6$$

According to Equation 6, the MAP estimate Îₖ is based on the noise conditional density Pr(Iₖⁿ|Iₖ) and the priori conditional density Pr(Iₖ|Îₖ₋₁).

### Noise Conditional Density Model

Given an original frame Iₖ, the noise conditional density Pr(Iₖⁿ|Iₖ) is determined by the noise's distribution in Equation 1 above. Generally, the noise satisfies or is similar to Gaussian distribution. The density for a Gaussian distribution is defined as having mean μₙ, and variance σₙ² as

$${P}_{z} ( z ) = N ( μ , {σ}_{n}^{2} ) = \frac{1}{\sqrt{2 π} {σ}_{n}} {exp}^{- \frac{{( z - {μ}_{n} )}^{2}}{2 {σ}_{n}^{2}}} \qquad Eqn . 7$$

According to Equations 1 and 7, the minus log of the conditional density −log [Pr(Iₖⁿ|Iₖ)], which is the first term in Equation 6, can be expressed as:

$$- log [ Pr ( {I}_{k}^{n} \vert {I}_{k} ) ] = \frac{{( {I}_{k}^{n} - {I}_{k} - {μ}_{n} )}^{2}}{2 {σ}_{n}^{2}} - log [ \frac{1}{\sqrt{2 π} {σ}_{n}} ] \qquad Eqn . 8$$

### A Priori Conditional Density Model

With video denoising to remove noise in a current frame, the current frame can be viewed as a “corrupted” version of the previous frame:

Iₖ=AÎₖ₋₁+r Eqn. 9

where A can be seen as motion estimation matrix and r is the residue after motion compensation.

Assuming r satisfies the following density function:

Pr(r)=κ exp^{-λΦ(r)} Eqn. 10

Then, the second term in Equation 6 (a priori conditional density) can be written as:

−log [Pr(Iₖ|Îₖ₋₁)]=λΦ(Iₖ−AÎₖ₋₁)−log(κ) Eqn. 11

### Relation to Rate Distortion Optimization

Combining Equations 8 and 11, assuming μₙ=0, and ignoring the constant term (since the minimization is over Iₖ and the constant term is independent of Iₖ, ignoring the constant term has no effect on the optimization and denoising processes of interest), Equation 6 reduces to:

$${\hat{I}}_{k} = arg {min}_{{I}_{k}} [ \frac{{( {I}_{k}^{n} - {I}_{k} )}^{2}}{2 {σ}_{n}^{2}} + λΦ ( {I}_{k} - {A}_{{\hat{I}}_{k - 1}} ) ] \qquad Eqn . 12$$

The first term (Iₖⁿ−Iₖ)² in Equation 12 can be seen as the distortion Dₖ between the noisy data and the estimate of the original data. By defining the second term Φ(Iₖ−AÎₖ₋₁) as the bit rate Rₖ of the residue Iₖ−AÎₖ₋₁, Equation 12 can be re-written as follows:

$${\hat{I}}_{k} = arg {min}_{{I}_{k}} ( {D}_{k} + α {R}_{k} ) \qquad Eqn . 13$$

Here, the energy function Φ( ) is measured by the bit rate R of the motion compensated residue. This is reasonable, since for the natural video, the bit rate R of the residue is usually quite small. However, for the noisy video, the bit rate may become large. Therefore, finding the reconstruction frames with a small bit rate of the residue equates to reducing the noise.

In accordance with an embodiment, from Equation 13, the minimization is observed to be over two objective functions Dₖ and Rₖ based on the regularization parameter α. Given α, an optimal solution for Equation 13 can be determined. However, determining a suitable α in the form of Equation 13 can be challenging. Thus, in one embodiment, equation 13 is solved as a constrained minimization problem, as follows:

$${min}_{{I}_{k}} {R}_{k} s . t . {D}_{k} \leq {D}_{k}^{0} \qquad Eqn . 14$$

where Dₖ⁰ is the threshold, which is determined by the noise's variance and the quantization parameter. By fixing Dₖ⁰, the optimal lagrangian parameter α can be found for Equation 13. In this respect, the MAP estimate Îₖ is a compressed version of the noisy data Iₖⁿ. Therefore, the system operates to simultaneously compress the video signal and remove the noise.

To determine an output of Equation 14, generally, the bit rate R is assumed to be a function of the distortion D as follows:

$$R ( D ) = β log ( \frac{η}{D} ) \qquad Eqn . 15$$

Since the R(D) function in the Equation 15 is convex in term of D, the optimization problem in Equation 14 is convex and the optimal solution can be achieved by solving the following Karush-Kuhn-Tucker (KKT) conditions:

$$\begin{matrix}\frac{\partial {R}_{k} ( {D}_{k} )}{\partial {D}_{k}} + \frac{1}{α} = 0 {D}_{k} - {D}_{k}^{0} \leq 0 & Equation 16 a \\ \frac{1}{α} \geq 0 \frac{1}{α} ( {D}_{k} - {D}_{k}^{0} ) = 0 & Equation 16 b\end{matrix}$$

obtaining the following result:

$$α = \frac{{D}_{k}^{0}}{β} \qquad Equation 17$$

According to Equation 13, α is the lagrangian parameter in the rate distortion optimization problem. Therefore, for instance, the lagrangian parameter in the H.264 coding standard, which is a commonly used video compression standard, should be:

$${λ}_{mode} = α = \frac{{D}_{k}^{0}}{β} \qquad Equation 18$$

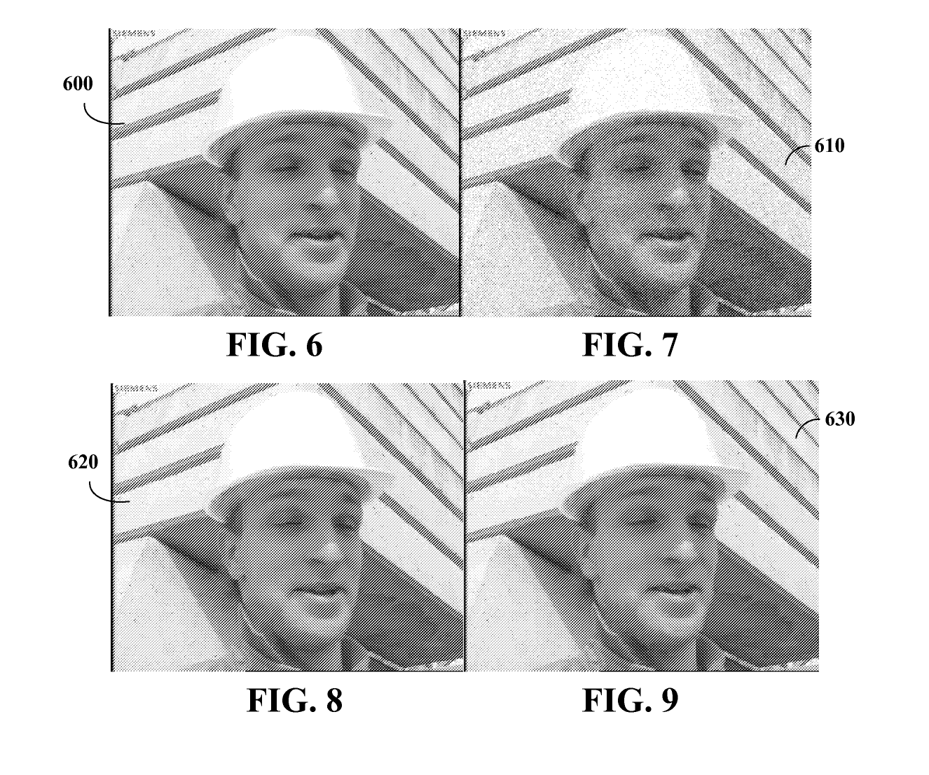

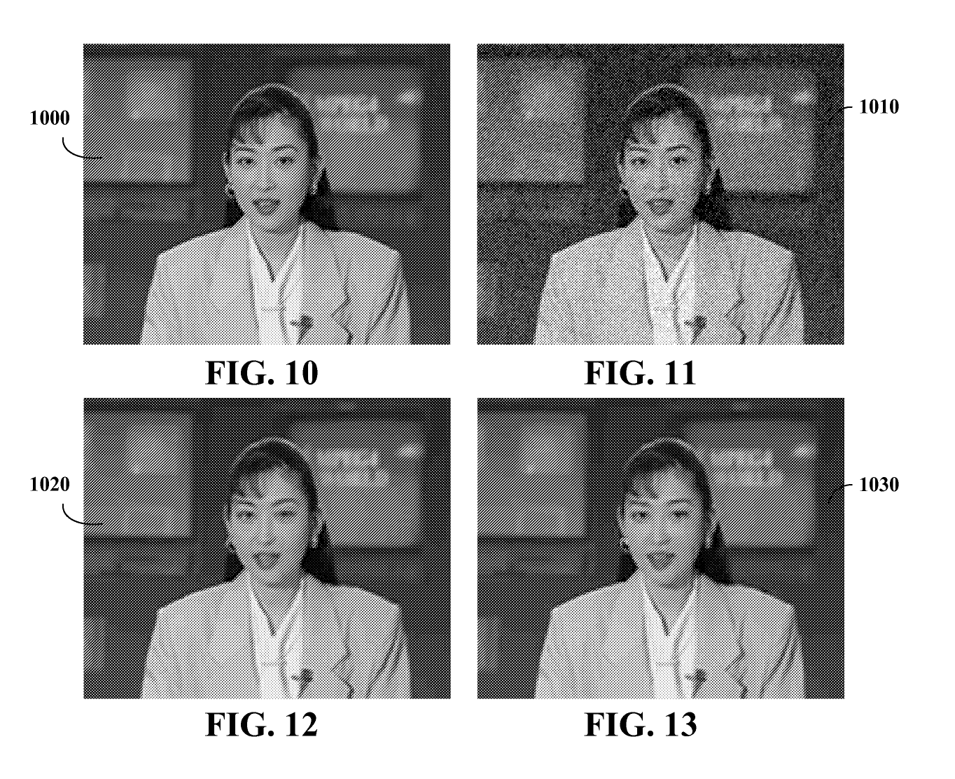

The video denoising algorithm described for various embodiments herein was also evaluated based on an exemplary non-limiting H.264 implementation. To simulate noising of a video, clean video sequences were first manually distorted by adding Gaussian noise. Then, the noisy videos were denoised by using the above-described techniques. As shown in FIGS. 6 to 9 and 10 to 13, respectively, the efficacy of the techniques can be visually observed in two separate video sequences. FIGS. 6, 7, 8 and 9 show the same frame as an original capture 600, an intentionally noised version of the original capture 610, a reconstruction of the original capture after H.264 decompression 620 and a reconstruction of the noised version after application of the denoising 630 as described in various embodiments herein, respectively. Similarly, for a different original capture, FIGS. 10, 11, 12 and 13 show the original capture 1000, an intentionally noised version of the original capture 1010, a reconstruction of the original capture after H.264 decompression 1020 and a reconstruction of the noised version after application of the denoising 1030 as described herein, respectively.

Operation was observed to perform well over a variety of different selected noise variances. In one non-limiting implementation, the parameters Dₖ⁰ and β were set to be Dₖ⁰=σ²/2 and β=0.392, respectively. The peak signal to noise ratio (PSNR) can be computed by comparing with the original video sequence, and can be used to quantify what is shown in FIGS. 6 to 9 and 10 to 13 by comparing the performance of three PSNR measurements: the PSNR of the noisy video 610, 1010, the PSNR of the reconstructed video by using a H.264 encoder for the original (clean) video 620, 1020, and the PSNR of the reconstructed video 630, 1030 by using the embodiments described herein for the noisy video. For the latter two methods where the video is reconstructed with a H.264 encoder, the quantization parameter (QP) was varied in accordance with the noise variance.

Thus, FIGS. 6 to 13 show the PSNR performance of two separate video sequences which, in one example, are distorted by Gaussian noise N(0,100). The various embodiments described herein significantly outperform the noisy video in terms of PSNR, which means that the noise is greatly reduced. The PSNR performance is thus observed to be better than even the encoded version of original video by using H.264. This is because when QP is set to be 35, for example, a lot of high frequency content of the original video is quantized, which can make the reconstructed video over-smooth whereas with the embodiments described herein, since the noise may partly penalize the over-quantized high frequency, over-smoothing of the video is avoided. The visual quality of the reconstructed video is also examined. A visual inspection of frames 630 and 1030 of FIGS. 9 and 13, respectively, also shows that the embodiments described herein can greatly reduce noise and restore the original video with the same or even better visual quality when compared with the compressed version of the original video in frames 620 and 1020.

In Table I below, the average PSNR performance comparison for test sequences is shown for noise variances of 49, 100, and 169, respectively. In one non-limiting implementation, it was observed that the PSNR performance is about 4 to 10 dB (e.g., 3.823˜10.186 dB) higher than that of the noisy video, a significant improvement.

TABLE I
Comparison of PSNRs for Different Variances and Techniques

| | PSNR (dB) | | | | | |
|---|---|---|---|---|---|---|
| | Video of FIGS. 5A to 5D | | | Video of FIGS. 6A to 6D | | |
| | σₙ² = 49 | σₙ² = 100 | σₙ² = 169 | σₙ² = 49 | σₙ² = 100 | σₙ² = 169 |
| Noisy | 31.226 | 28.144 | 24.121 | 31.225 | 28.130 | 24.069 |
| H.264 | 34.514 | 32.815 | 31.115 | 37.105 | 35.669 | 34.497 |
| Rate | 35.049 | 33.791 | 31.263 | 38.023 | 36.413 | 34.255 |
| Distortion | | | | | | |
| Optimized | | | | | | |
| Denoising | | | | | | |

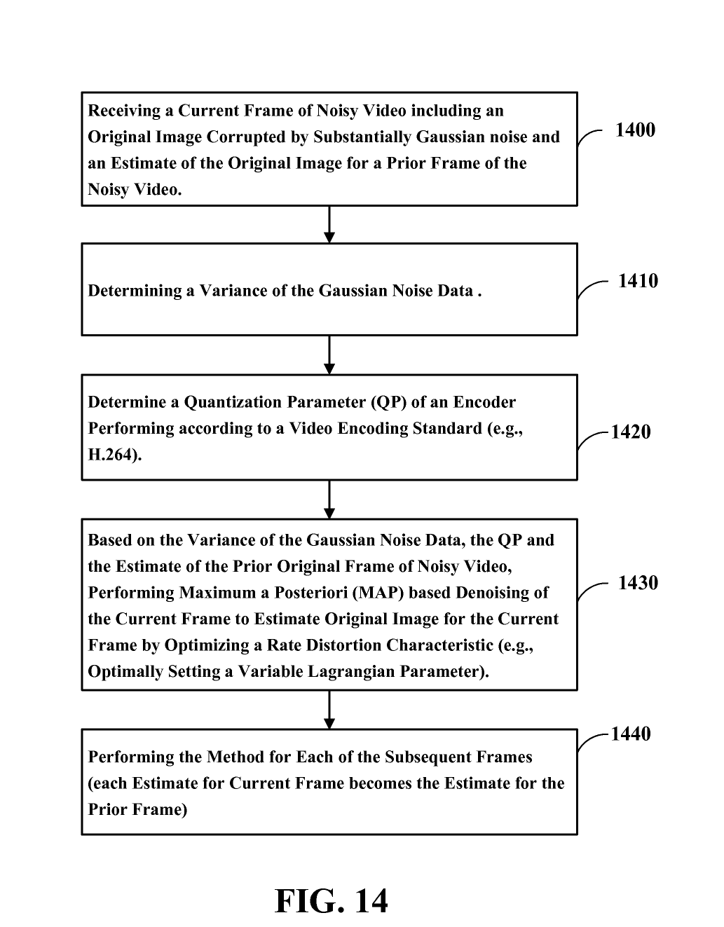

FIG. 14 illustrates another exemplary flow diagram for performing denoising. At 1400, a current frame of noisy video including an original image corrupted by substantially Gaussian noise and an estimate of the original image for a prior frame of the noisy video are received. At 1410, a variance of the Gaussian noise data is determined, and a quantization parameter (QP) of an H.264 encoder is set at 1420. At 1430, based on the variance of the Gaussian noise, the QP and estimate of the prior frame, MAP-based denoising of the current frame is performed to estimate the original image for the current frame via rate distortion optimization (e.g., optimally setting a variable lagrangian parameter). Lastly, at 1440, the procedure can be repeated for the subsequent frames in order to denoise the sequence of images represented by the noisy video.

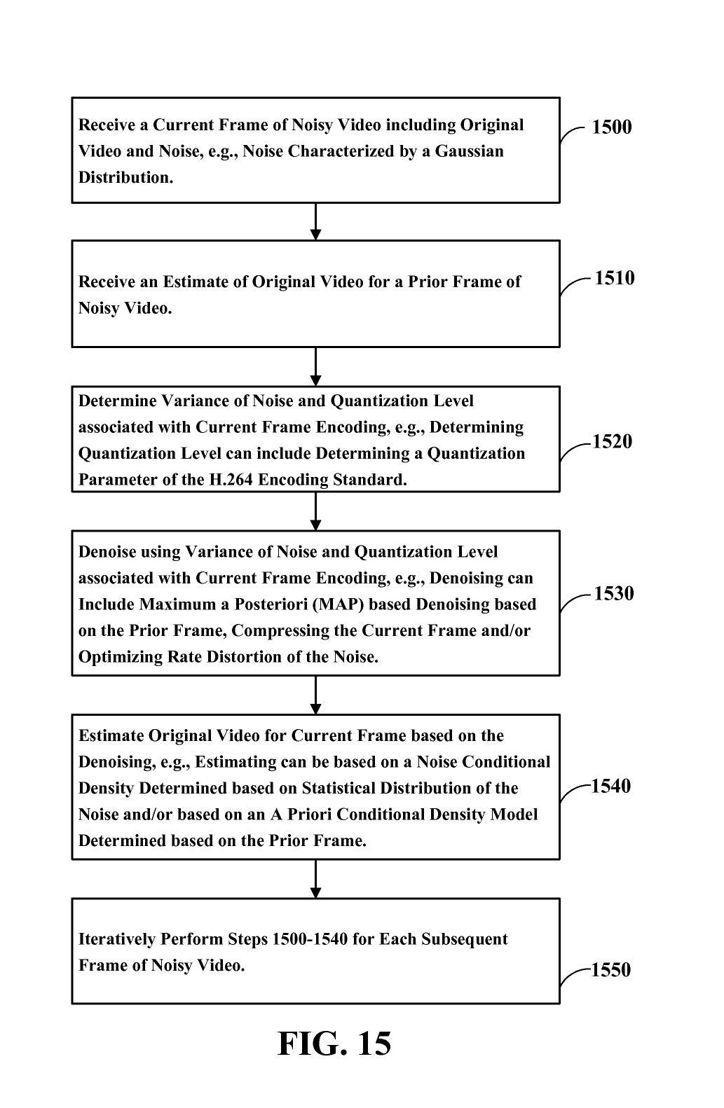

FIG. 15 is an additional flow diagram illustrating exemplary MAP-based techniques applied to determine an optimal reconstruction of an original video signal. At 1500, a current frame of noisy video is received, retrieved or accessed, including original video and noise, e.g., noise characterized by a Gaussian distribution. At 1510, an estimate of original video for a prior frame of noisy video is received, retrieved or accessed. Such access could be from memory, such as, but not limited to RAM, flash, a video buffer, etc., or could be provided as part of a stream, e.g., live stream from camera. In this respect, the techniques herein can be applied anywhere that video signals are represented as frames in sequence.

At 1520, the variance of noise and quantization level associated with current frame encoding is determined. Determining the quantization level can include determining a quantization parameter of the H.264 encoding standard. At 1530, denoising is performed based on the variance of noise and quantization level associated with current frame encoding. Denoising can include maximum a posteriori (MAP) based denoising based on the prior frame, compressing the current frame and/or optimizing rate distortion of the noise. At 1540, original video for the current frame is estimated based on the denoising. For example, estimating can be based on a noise conditional density determined from the statistical distribution of the noise and/or based on an a priori conditional density model determined based on the prior frame. At 1550, steps 1500-1540 are iteratively performed for each subsequent frame of noisy video to denoise a designated sequence of the video.

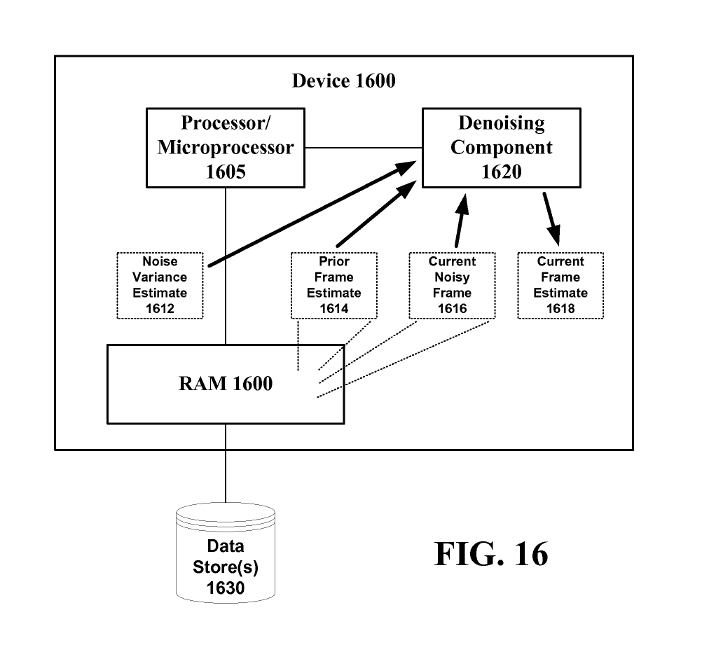

FIG. 16 is a block diagram illustrating exemplary MAP-based techniques applied to determine an optimal reconstruction of an original video signal. As shown a device 1600 includes storage, such as RAM 1600, and one or more processors or microprocessors 1605 for processing video data received by the system (e.g., live stream, or streaming video), or stored and retrieved in a local or remote data store 1630. In various embodiments, a denoising component takes noisy video as input (e.g., received live or stored). In one aspect, denoising component determines a noise variance estimate 1612. Then, based on the estimate 1612, for each current frame after the first frame, the denoising component takes a prior frame estimate 1614 and a current noisy frame 1616, and determines an estimate of the current frame 1618.

FIG. 16 thus illustrates a video denoising system for denoising noisy video data received by a computing system including a data store for storing frames of noisy video data, each frame including original image data and noise image data characterizable by a Gaussian distribution. The system further includes a denoising component that determines a variance of the noise image data for the frames of noisy video data and performs maximum a posteriori (MAP) based denoising of a current frame, as described above, based on an estimate of the original video data for one or more prior frames of noisy video data and the variance. In this fashion, the denoising component optimally determines an estimate of the original image data of the current frame without the noise image data.

In one embodiment, the estimate of original video data for the one or more prior frames is at least one MAP-based estimate determined by the denoising component. The denoising component can include a H.264 encoder for encoding the output of the MAP based denoising performed by the denoising component according to the H.264 format. In one embodiment, the denoising component further determines a level of quantization associated with an encoding of the current frame.

In other embodiments, the denoising component optimally determines the estimate of the original image data of the current frame by optimally setting a variable lagrangian parameter. In this regard, the denoising component optimally sets a variable lagrangian parameter associated with a rate distortion function based on a distortion between the noise image data and the estimate and a bit rate associated with a residue after motion compensation. As a result, the denoising component achieves an increase in peak signal to noise ratio (PSNR) of the estimate of the original data over the PSNR of the current frame including the noise image data substantially in the range of about 4 to 10 decibels.

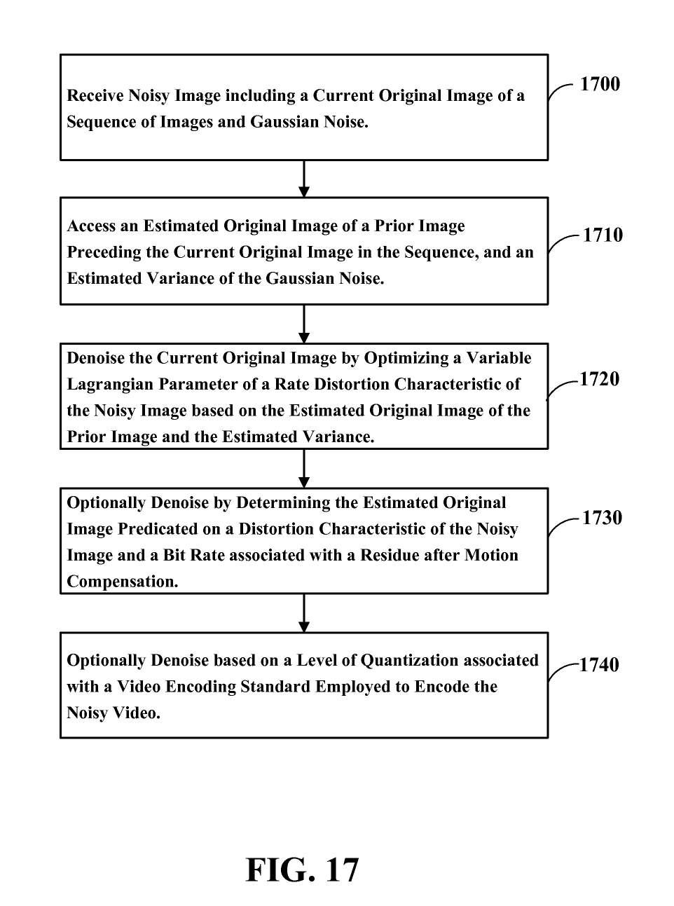

FIG. 17 is an additional flow diagram illustrating exemplary MAP-based techniques applied to determine an optimal reconstruction of an original video signal. At 1700, a noisy image is received by the system including a current original image of a sequence of images and Gaussian noise. At 1710, an estimated original image of a prior image preceding the current original image in the sequence is accessed, and an estimated variance of the Gaussian noise is received or determined. At 1720, the current original image is denoised by optimizing a variable Lagrangian parameter of a rate distortion characteristic of the noisy image based on the estimated original image of the prior image and the estimated variance. Optionally, at 1730, the denoising can include determining the estimated original image predicated on a distortion characteristic of the noisy image and a bit rate associated with a residue after motion compensation. As another option, at 1740, denoising can be performed based on a level of quantization associated with a video encoding standard employed to encode the noisy video.

### Exemplary Computer Networks and Environments

One of ordinary skill in the art can appreciate that the various embodiments of cooperative concatenated coding described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may implement one or more aspects of cooperative concatenated coding as described for various embodiments of the subject disclosure.

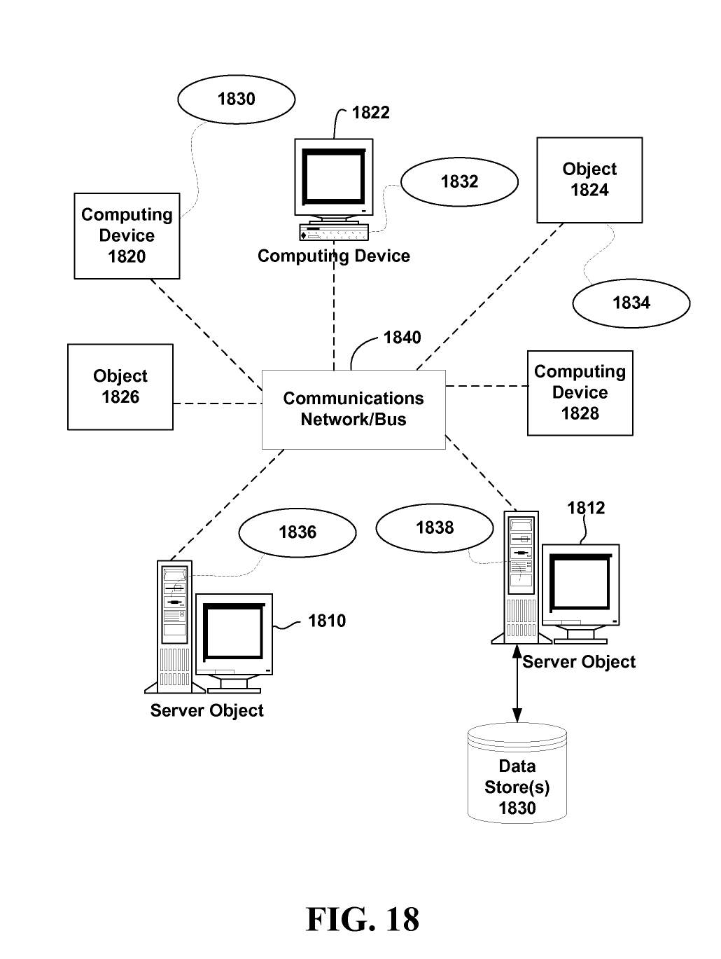

FIG. 18 provides a schematic diagram of an exemplary networked or distributed computing environment. The distributed computing environment comprises computing objects 1810, 1812, etc. and computing objects or devices 1820, 1822, 1824, 1826, 1828, etc., which may include programs, methods, data stores, programmable logic, etc., as represented by applications 1830, 1832, 1834, 1836, 1838. It can be appreciated that objects 1810, 1812, etc. and computing objects or devices 1820, 1822, 1824, 1826, 1828, etc. may comprise different devices, such as PDAs, audio/video devices, mobile phones, MP3 players, personal computers, laptops, etc.

Each object 1810, 1812, etc. and computing objects or devices 1820, 1822, 1824, 1826, 1828, etc. can communicate with one or more other objects 1810, 1812, etc. and computing objects or devices 1820, 1822, 1824, 1826, 1828, etc. by way of the communications network 1840, either directly or indirectly. Even though illustrated as a single element in FIG. 18, network 1840 may comprise other computing objects and computing devices that provide services to the system of FIG. 18, and/or may represent multiple interconnected networks, which are not shown. Each object 1810, 1812, etc. or 1820, 1822, 1824, 1826, 1828, etc. can also contain an application, such as applications 1830, 1832, 1834, 1836, 1838, that might make use of an API, or other object, software, firmware and/or hardware, suitable for communication with or implementation of the cooperative concatenated coding architecture(s) provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the cooperative concatenated coding as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 18, as a non-limiting example, computers 1820, 1822, 1824, 1826, 1828, etc. can be thought of as clients and computers 1810, 1812, etc. can be thought of as servers where servers 1810, 1812, etc. provide data services, such as receiving data from client computers 1820, 1822, 1824, 1826, 1828, etc., storing of data, processing of data, transmitting data to client computers 1820, 1822, 1824, 1826, 1828, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for performing cooperative concatenated coding can be provided standalone, or distributed across multiple computing devices or objects.

In a network environment in which the communications network/bus 1840 is the Internet, for example, the servers 1810, 1812, etc. can be Web servers with which the clients 1820, 1822, 1824, 1826, 1828, etc. communicate via any of a number of known protocols, such as the hypertext transfer protocol (HTTP). Servers 1810, 1812, etc. may also serve as clients 1820, 1822, 1824, 1826, 1828, etc., as may be characteristic of a distributed computing environment.

### Exemplary Computing Device

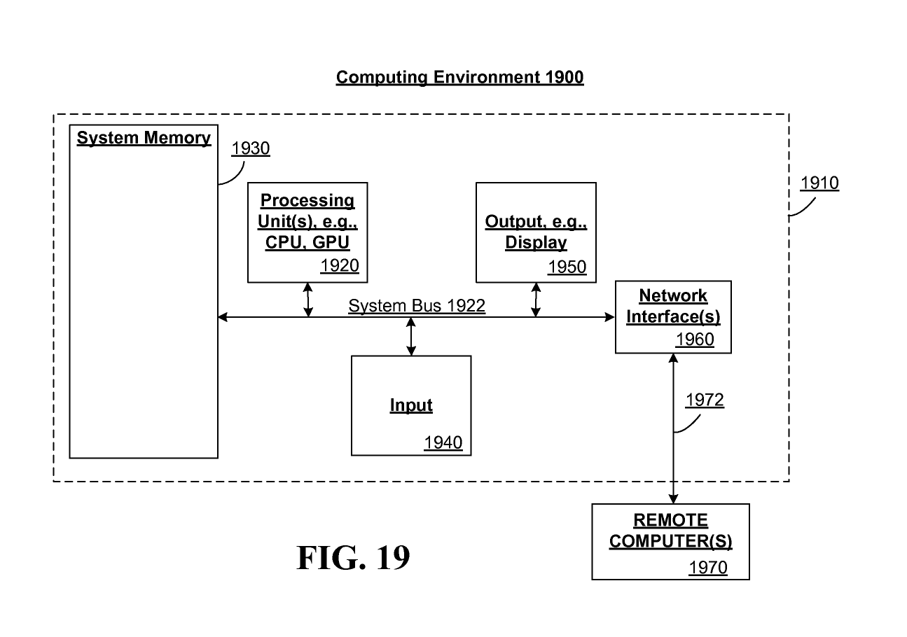

As mentioned, advantageously, the techniques described herein can be applied to any device where it is desirable to transmit data from a set of cooperating users. It should be understood, therefore, that handheld, portable and other computing devices and computing objects of all kinds are contemplated for use in connection with the various embodiments, i.e., anywhere that a device may wish to transmit (or receive) data. Accordingly, the below general purpose remote computer described below in FIG. 19 is but one example of a computing device. Additionally, any of the embodiments implementing the cooperative concatenated coding as described herein can include one or more aspects of the below general purpose computer.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 19 thus illustrates an example of a suitable computing system environment 1900 in which one or aspects of the embodiments described herein can be implemented, although as made clear above, the computing system environment 1900 is only one example of a suitable computing environment and is not intended to suggest any limitation as to scope of use or functionality. Neither should the computing environment 1900 be interpreted as having any dependency or requirement relating to any one or combination of components illustrated in the exemplary operating environment 1900.

With reference to FIG. 19, an exemplary remote device for implementing one or more embodiments includes a general purpose computing device in the form of a computer 1910. Components of computer 1910 may include, but are not limited to, a processing unit 1920, a system memory 1930, and a system bus 1922 that couples various system components including the system memory to the processing unit 1920.

Computer 1910 typically includes a variety of computer readable media and can be any available media that can be accessed by computer 1910. The system memory 1930 may include computer storage media in the form of volatile and/or nonvolatile memory such as read only memory (ROM) and/or random access memory (RAM). By way of example, and not limitation, memory 1930 may also include an operating system, application programs, other program modules, and program data.

A user can enter commands and information into the computer 1910 through input devices 1940. A monitor or other type of display device is also connected to the system bus 1922 via an interface, such as output interface 1950. In addition to a monitor, computers can also include other peripheral output devices such as speakers and a printer, which may be connected through output interface 1950.

The computer 1910 may operate in a networked or distributed environment using logical connections to one or more other remote computers, such as remote computer 1970. The remote computer 1970 may be a personal computer, a server, a router, a network PC, a peer device or other common network node, or any other remote media consumption or transmission device, and may include any or all of the elements described above relative to the computer 1910. The logical connections depicted in FIG. 19 include a network 1972, such local area network (LAN) or a wide area network (WAN), but may also include other networks/buses. Such networking environments are commonplace in homes, offices, enterprise-wide computer networks, intranets and the Internet.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations and embodiments described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the embodiments described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the techniques. In the case of program code execution on programmable computers, the computing device generally includes a processor, a storage medium readable by the processor (including volatile and non-volatile memory and/or storage elements), at least one input device, and at least one output device.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described sura, methodologies that may be implemented in accordance with the disclosed subject matter will be better appreciated with reference to the various flowcharts. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the embodiments have been described in connection with the embodiments of the various figures, it is to be understood that other similar embodiments may be used or modifications and additions may be made to the described embodiment for performing the same function without deviating therefrom.

While exemplary embodiments may be presented in the context of particular programming language constructs, specifications or standards, such embodiments are not so limited, but rather may be implemented in any language to perform the optimization algorithms and processes. Still further, embodiments can be implemented in or across a plurality of processing chips or devices, and storage may similarly be effected across a plurality of devices. Therefore, the invention should not be limited to any single embodiment, but rather should be construed in breadth and scope in accordance with the appended claims.

What is claimed is:

1. A method for denoising noisy video data, comprising:
receiving a current frame of noisy video data including original video data and noise data;
receiving an estimate of original video data for a prior frame of noisy video data;
determining a variance of the noise data and a level of quantization associated with an encoding of the current frame;
based on at least the variance of the noise data, the level of quantization and the estimate of original video data for a prior frame of noisy video data, denoising the current frame; and
estimating original video data for the current frame based on the denoising.

2. The method of claim 1, further comprising:
iteratively performing the receiving, determining, denoising and estimating steps for each subsequent frame of noisy video data.

3. The method of claim 1, wherein the determining of the level of quantization includes determining a quantization parameter of an encoder performing according to the H.264 video encoding standard.

4. The method of claim 1, wherein the estimating includes estimating based on a noise conditional density determined based on statistical distribution of the noise data.

5. The method of claim 1, wherein the estimating includes estimating based on an a priori conditional density model determined based on the prior frame.

6. The method of claim 1, wherein the denoising includes maximum a posteriori (MAP) based denoising based on the prior frame.

7. The method of claim 1, wherein the denoising includes compressing the current frame.

8. The method of claim 1, wherein the denoising includes optimizing a rate distortion characteristic of the noise data.

9. The method of claim 1, wherein the receiving includes receiving a current frame of noisy video data including original video data and noise data characterized by a Gaussian distribution.

9. A computer readable medium comprising computer executable instructions for performing the method of claim 1.

10. A video denoising system for denoising noisy video data received by a computing system, comprising:
at least one data store for storing a plurality of frames of noisy video data, each frame including original image data and noise image data characterizable by a Gaussian distribution; and
a denoising component that determines a variance of noise image data for the plurality of frames of noisy video data and performs maximum a posteriori (MAP) based denoising of a current frame based on at least one estimate of original video data for at least one prior frame of noisy video data and the variance, wherein the denoising component optimally determines an estimate of the original image data of the current frame without the noise image data.

11. The video denoising system of claim 10, wherein the at least one estimate of original video data for the at least one prior frame is at least one MAP-based estimate determined by the denoising component.

12. The video denoising system of claim 10, further comprising:
a H.264 encoder for encoding the output of the MAP based denoising performed by the denoising component according to the H.264 format.

13. The video denoising system of claim 10, wherein the denoising component further determines a level of quantization associated with an encoding of the current frame.

14. The video denoising system of claim 10, wherein the denoising component optimally determines the estimate of the original image data of the current frame by optimally setting a variable lagrangian parameter.

15. The video denoising system of claim 14, wherein the denoising component optimally sets a variable lagrangian parameter associated with a rate distortion function based on a distortion between the noise image data and the estimate and a bit rate associated with a residue after motion compensation.

16. The video denoising system of claim 14, wherein the denoising component achieves an increase in peak signal to noise ratio (PSNR) of the estimate of the original data over the PSNR of the current frame including the noise image data substantially in the range of about 4 to 10 decibels.

17. A method for processing noisy video data including a sequence of original images and a corresponding sequence of noise data embedded in the original images, comprising:
receiving a noisy image including an original image and Gaussian noise; and
based on an estimated original image of a prior image preceding the original image in the sequence, and a variance of the Gaussian noise, denoising the current frame including optimizing a variable lagrangian parameter associated with a rate distortion characteristic of the noisy image.

18. The method of claim 17, wherein the denoising includes determining the estimated original image predicated on a distortion characteristic of the noisy image.

19. The method of claim 17, wherein the denoising includes determining the estimated original image predicated on a bit rate associated with a residue after motion compensation.

20. The method of claim 17, wherein the denoising further includes denoising based on a level of quantization associated with a video encoding standard employed to encode the noisy video data.
